(19) United States
(12) Patent Application Publication
(10) Pub. No.: US 2014/0137637 A1
(43) Pub. Date: May 22, 2014

(54) AIR PERMEABILITY TESTER

(71) Applicant: Nils Fretz, Uetikon a. See (CH)

(72) Inventor: Nils Fretz, Uetikon a. See (CH)

(73) Assignee: TEXTEST AG, Schwerzenbach (CH)

(21) Appl. No.: 14/130,862

(22) PCT Filed: Jul. 8, 2011
(86) PCT No.: PCT/EP2011/061686

§ 371 Date: Jan. 3, 2014

(51) Int. Cl. G01N 15/08

(52) U.S. Cl. CPC G01N 15/0826
USPC 73/38

(57) ABSTRACT

An air permeability apparatus has a test head with an opening, a vacuum pump, a clamping arm and an orifice disk arranged between the test head and the vacuum pump, wherein the orifice disk has a plurality of orifices. The orifice disk is arranged vertically or inclined with respect to the opening.

The present invention relates to an air permeability apparatus and to a method of for measuring air permeability with an air permeability apparatus.

Air permeability apparatus are utilized to determine air permeability of all kinds of flat materials and of foam cubes. The measuring range covers dense papers and airbag fabrics as well as non-wovens.

Substantially, known air permeability apparatus comprise a test head with an opening, a vacuum pump for drawing air through the opening of the test head and a clamping arm. The air flow through the test specimen is determined with an orifice disk having orifices of different sizes. The air permeability of the test specimen is determined from the pressure drop across the orifice of the orifices, where said pressure drop occurs.

One object of the present invention is to provide an improved air permeability apparatus.

The object is solved by the features given in claim 1. Further embodiments of the present invention are given in dependant claims.

An air permeability apparatus is suggested comprising a test head with an opening, a vacuum pump, a clamping arm and an orifice disk being arranged between the test head and the vacuum pump. Furthermore, the orifice disk has a plurality of orifices and is arranged rotatably around its central axis, wherein the orifice disk is arranged vertically or inclined with respect to the opening of the test head. Thereby dust deposit in the orifices of the orifice disk is prevented to a great extent. Thus, an accurate test result can be obtained since falsification of the test result is prevented and since unwanted pressure drop is averted.

In an embodiment, the orifice disk is arranged inclined in an angle between 10° to 90°, in particular between 30° to 80°, in particular 40° to 70°, or at 90°.

In another embodiment, the orifice disk comprises at least one slit being arranged in radial manner between two orifices with respect to the orifice disk. Thereby, a dust deposit inside the tube can easily be removed in aspirating the dust by activating the vacuum pump, if need be. It is also conceivable to arrange two slits opposite to each other for example in the orifice disk.

In a further embodiment, the slit extends from an area of the perimeter of the orifice disk towards a central opening of the orifice disk and the length of the slit overlaps a contact area between a first ending of a tube and the orifice disk when the slit is in a cleaning position.

In another embodiment, an air jet nozzle is aimed towards the orifice disk. Thereby, possible dust deposit in the orifices can easily be removed. Furthermore, damages caused by possibly deposited scratching dust particles due e.g. to a sealing element arranged between the pump and the orifice disk is prevented. Thus, the contact area between the tube and the orifice disk remains airtight.

In a further embodiment, the orifices are arranged in radial manner with respect to the central opening.

In another embodiment, the orifices have a diameter in a range between 0.2 mm to 30 mm.

In another embodiment the orifice disk is made out of a material as metal, ceramics, resin, plastics, wherein the material is coated or uncoated.

In another embodiment, the clamping arm comprises a mounting structure, wherein a back part of the mounting structure is formed wider than the opening of the test head, preferably the mounting structure is bifurcated-like, wherein the mounting structure is pivotable attached to a socket. Thereby, a misalignment of the test head is prevented.

In another embodiment, the test head comprises a rapid connection, preferably a snap-on mounting, for connecting or disconnecting the test head to the clamping arm. Thereby, the test head is easily interchangeable.

In a further embodiment, the test head comprises a top part and a bottom part, which are connectable to each other by pressing the clamping arm downwards.

In another embodiment, the clamping arm comprises an analysis unit, preferably being designated to save and store series of data by using integrated software.

In another embodiment, another vacuum pump is connected to a closed casing, wherein the closed casing is provided in an area of the opening of the test head. Thereby, air leakage in a boundary area of the test specimen to be measured is prevented.

Another aspect on the invention relates to a method for measuring air permeability with an air permeability apparatus comprising a test head with an opening, a vacuum pump, a clamping arm and an orifice disk being arranged between the test head and the vacuum pump, wherein the orifice disk has a plurality of orifices and is arranged rotatably around its central axis and wherein the orifice disk is arranged vertically or inclined with respect to the test opening of the test head and wherein the orifice disk is arranged vertically spaced from the longitudinal axis of the opening of the test head, comprising the steps of:
before establishing a predetermined test pressure, a first cleaning step is performed in blowing air through the orifices of the orifice disk;
performing a second cleaning step in aspirating dust deposit of a tube via a slit of the orifice disk by activating the vacuum pump.

Thereby, possible dust deposit in the orifices or dust deposit in the tube can easily be removed without disassembling the apparatus, respectively. Thus, downtime of the apparatus is minimized. Furthermore, an accurate test result can be obtained since falsification of the test result is prevented.

The present invention is further explained with the aid of examples of embodiments, which are shown in figures. There is shown:

FIG. 1 schematically, an air permeability apparatus;

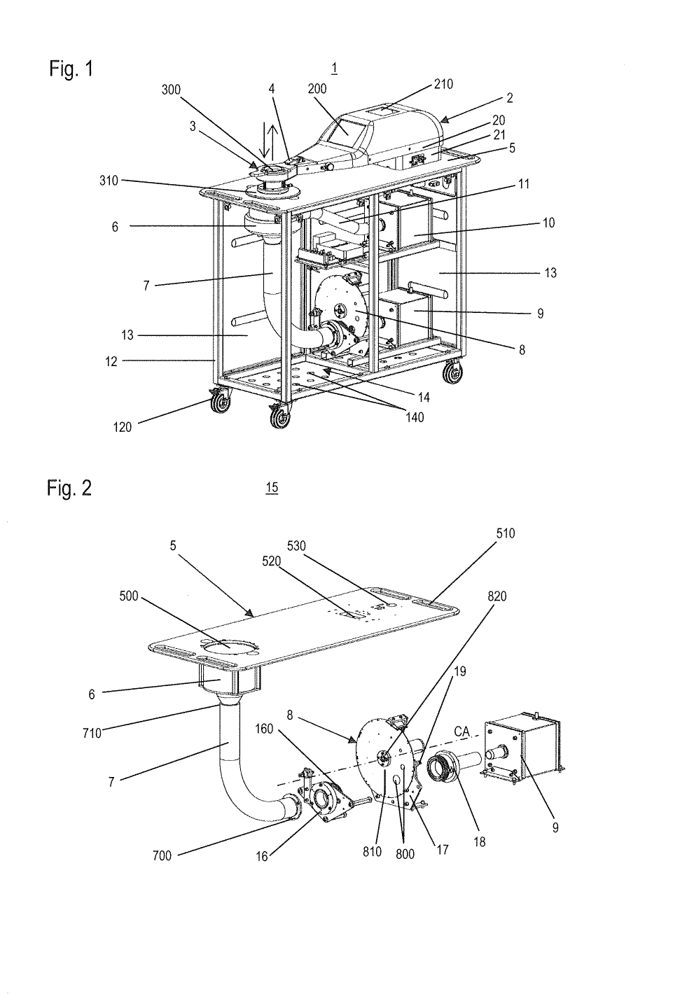

FIG. 2 schematically, an example of an orifice disk unit of an air permeability apparatus;

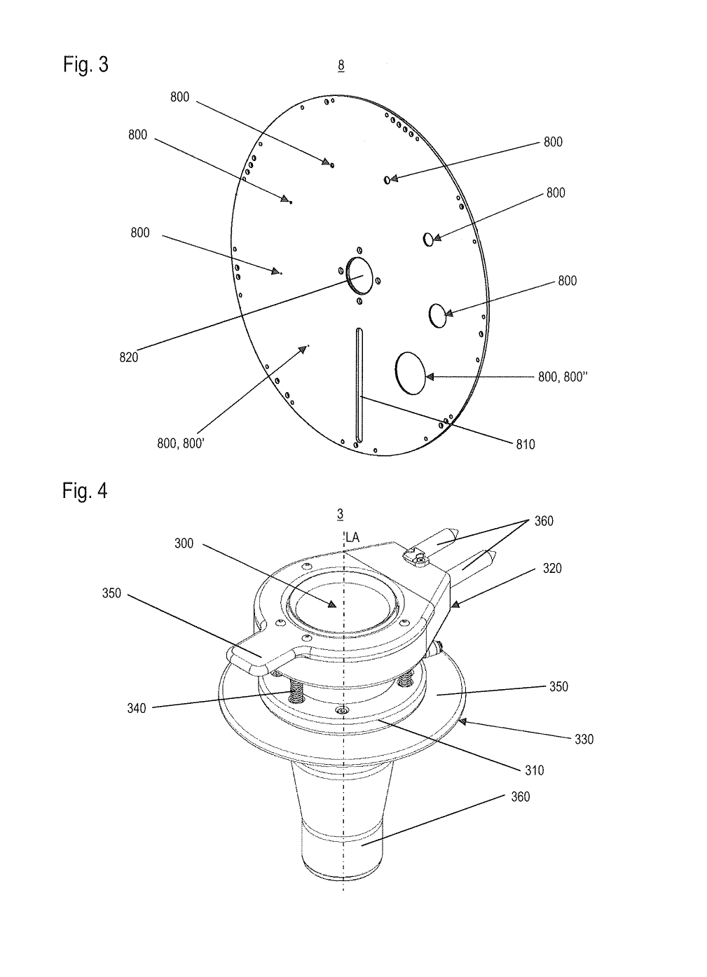

FIG. 3 an orifice disk magnified according to FIG. 2;

FIG. 4 schematically, a test head of an air permeability apparatus;

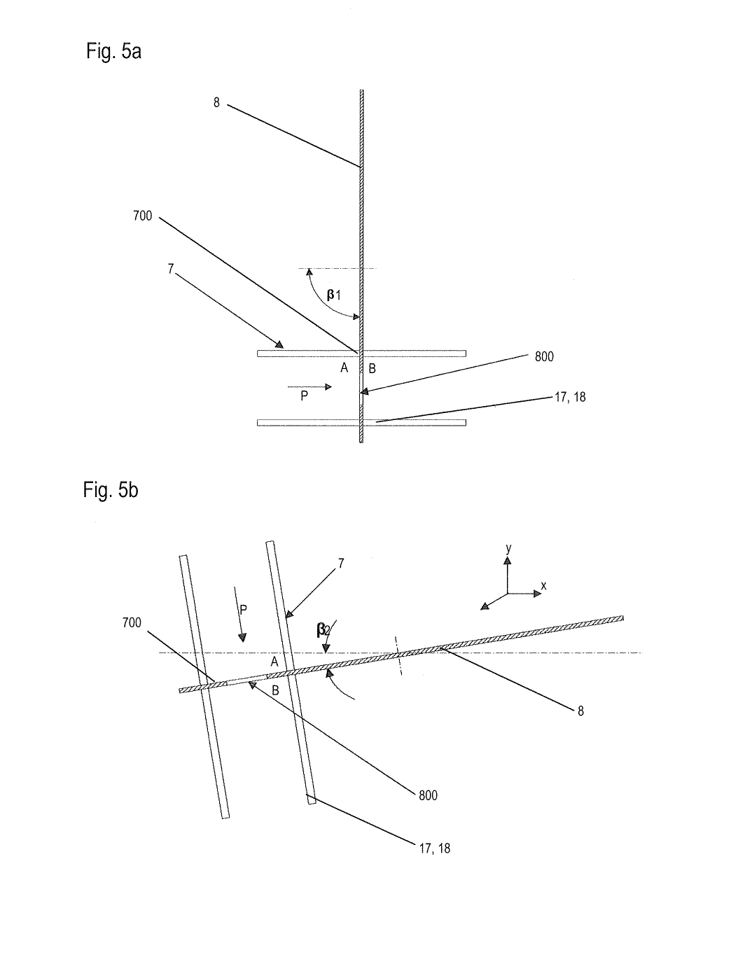

FIG. 5a schematically, a vertically arranged orifice disk;

FIG. 5b schematically, an inclined arranged orifice disk;

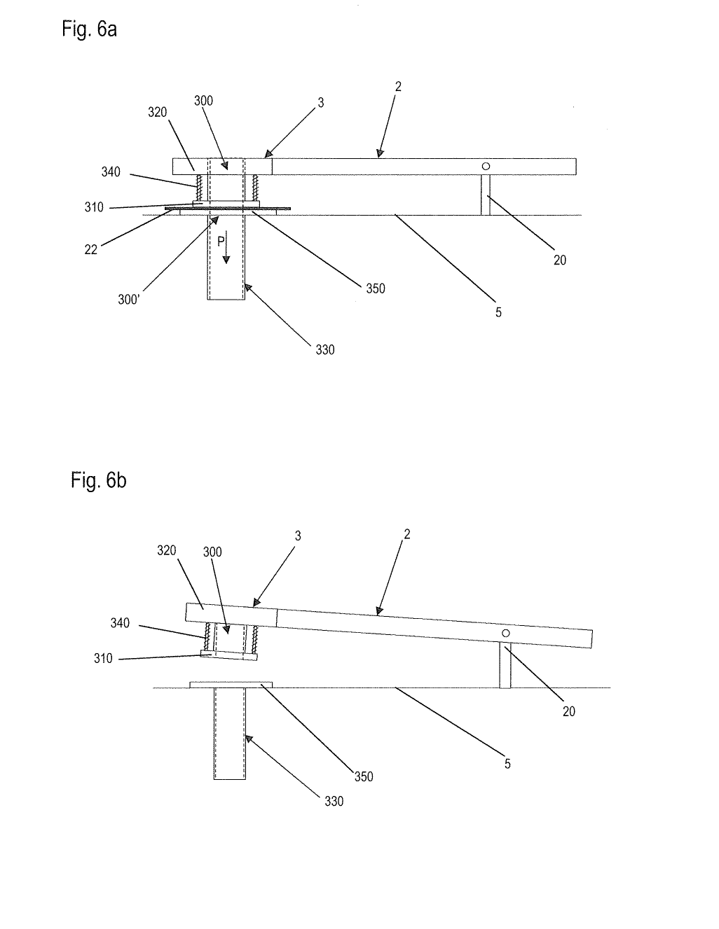

FIG. 6a schematically, a clamping arm pressed down against a test specimen;

FIG. 6b schematically, a clamping arm positioned in upward direction;

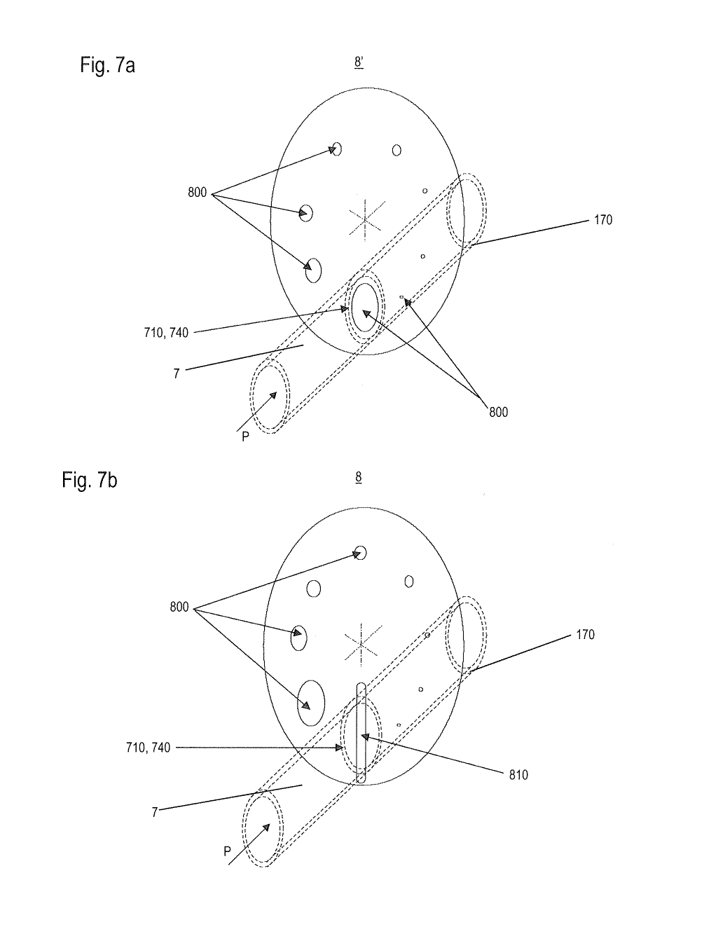

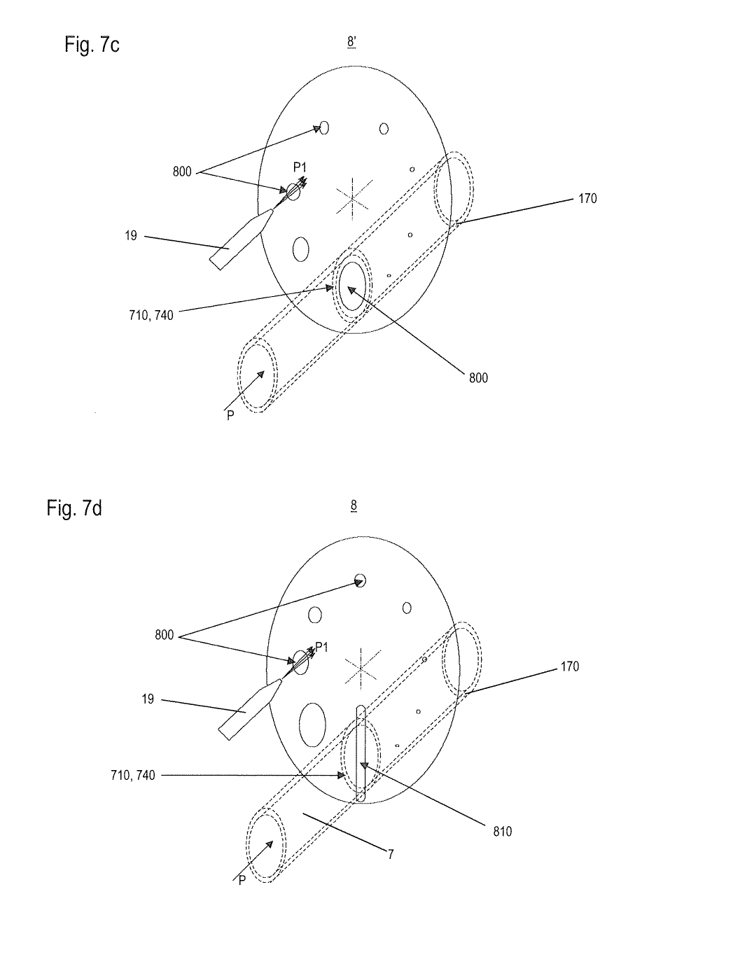

FIG. 7a schematically, another orifice disk; and

FIG. 7b schematically, a further orifice disk;

FIG. 7c schematically, another orifice disk; and

FIG. 7d schematically, another orifice disk.

In FIG. 1, schematically, an air permeability apparatus 1 is depicted. The air permeability apparatus 1 comprises an analysis unit 2 being operationally connected to a test head 3 having an opening 300. The analysis unit 2 comprises a screen 200 and a printer 210. The analysis unit 2 is designated to save and store series of data by using integrated software. A clamping arm 4 is arranged between the analysis unit 2 and the test head 3. The clamping arm 4 as depicted in FIG. 1 is pressed down such that a pressing plate 310 of the test head 3 contacts a work plate 5. The test head 3 is mounted in interchangeable manner. The appropriate test head 3 having an opening of a defined size for the test standard selected is mounted onto the clamping arm 4 to measure air permeability of a test specimen to be measured. The opening 300 runs throughout a top part of the test head 3 to a bottom part of the test head 3 carrying the pressing plate 310. A test specimen (not shown in FIG. 1) is arranged between the pressing plate 310 and the work plate 5 such that the opening 300 is covered by the test specimen. The test specimen can be of all kinds of flat materials or of foam cubes. The measuring range covers test specimens like dense papers and airbag fabrics as well as extremely open non-wovens and forming fabrics for example. After a test cycle is finished, the clamping arm 3 can be moved upward. The clamping arm 3 is pressed down again when starting another test cycle (see arrows depicted in FIG. 1). A closed casing 6 is arranged underneath the work plate 5 being connected to a tube 7. Furthermore, an orifice disk 8 is arranged between the tube 7 and a vacuum pump 9. The orifice disk 8 is arranged vertically with respect to the longitudinal axis of the longitudinal opening 300 of the test head 3. It is also conceivable to arrange the orifice disk 8 inclined with respect to the longitudinal axis (see also FIG. 4) of the longitudinal opening 300 of the test head 3. The vacuum pump 9 is activated automatically as soon as the clamping arm 4 is pressed down against the work table 5. A pre-selected test pressure is automatically maintained, and after a few seconds a test result of an air permeability of the test specimen is displayed at the screen 200. By pressing down the clamping arm 4 a second time the test-specimen is released and the vacuum pump 9 is shut-off. Another vacuum pump 10 is connected via another tube 11 to the casing 6. The other vacuum pump 10 is optionally mountable. The other vacuum pump 10 can be used in order to prevent an air leakage in a boundary area between the test specimen to be measured. Furthermore, a mounting frame 12 provided with side walls 13 and a bottom plate 14 with holes 140 is depicted in FIG. 1. The frame 12 is provided with wheels 120. The clamping arm 4 is mounted onto the table 5 with the aid of a mounting structure 20. The mounting structure 20 is pivotable attached to a socket 21 to allow a swivelling movement in upward or downward direction. A front of the mounting structure 20 is formed narrower than a back part of the mounting structure 20. The shape of the mounting structure 20 is bifurcated-like. Furthermore, the back part of the mounting structure 20 is formed wider than the opening 300 of the test head 3 being covered by the pressing plate 310. Thereby, mis-alignment of the test head 3 is prevented, even when the clamping arm 4 is pressed down unwarily by a user operating the air permeability test apparatus.

In FIG. 2, schematically, an example of an orifice disk unit 15 having only one single vacuum pump 9 is further explained. The orifice disk 8 is arranged between the vacuum pump 9 and the tube 7 in vertical position, wherein an ending 700 of the tube 7 is connectable to the orifice disk 8 via a carrier 16 with a central hole and further, the orifice disk 8 is connectable to the vacuum pump 9 via another carrier 17 and via a further tube 18 to the vacuum pump 9. The first carrier 16 comprises a sealing element 160, e.g. a sealing ring. The orifice disk 8 is formed like a flat disk having orifices 800 of different sizes and further having a slit 810 arranged in radial manner with respect to the disk-shaped orifice disk 8. Due to the vertically arranged orifice disk 8, only a very small amount of dust aspirated is deposited in the orifices 800 during a testing of a test specimen, e.g. a fibre. The disk-like orifice disk 8 is arranged rotably around its central axis CA. The air flow through a test specimen (not shown in FIG. 2) is measured by the aid of the orifices 800, whereby each of the orifices 800 is individually selectable in rotating the orifice disk 8 around its central axis CA. Thereby, the air flow through the test specimen can be measured by adjusting a diameter of the orifices 800 in rotating in selectable manner the orifice disk 8 relative to the tube 7 respectively to the carrier 16. The measured result of the air flow allows to determine pressure drop at a given air velocity. The air permeability of the test specimen is determined from the pressure drop across this specific orifice. Furthermore, an air jet nozzle 19 is mounted onto the other carrier 17. The air jet nozzle 19 serves to clean respectively to blow air through each of the orifices 800, if need be. The air jet nozzle 19 is arranged such that that the air jet nozzle 19 is aimed towards the orifice disk 8. A method for measuring air permeability with the aid of the air permeability apparatus 1 comprises a first cleaning step to clean the orifices, before measuring is started in establishing a determined test pressure. Pressurized air, for example, can be used to blow air trough the orifices 800. In a second, subsequent cleaning step, a dust deposit, originating e.g. from a previous measurement cycle, within the tube 7 is removed via the slit 810 in activating the vacuum pump 9. In this cleaning position, the slit 810 is arranged ahead an aperture of the ending 700 of the tube 7. The slit 810 extends from the perimeter or it is also conceivable that the slit extends from an area of the perimeter of the disk-like orifice disk 8 towards the central opening 820 and that the length of the slit overlaps the opening 300 of the test head 3 when the slit 810 is positioned in said cleaning position. The aperture of the ending 700 of the tube 7 is directed to the orifice disk 8. After blowing air through the orifices 800, the dust deposit resulting from the measuring operation and the dust deposit blown into the tube 7 due to the first cleaning step are removed from the tube 7 in activating the vacuum pump 9. A second ending 710 of the tube 7 is connected to the closed casing 6. The closed casing 6 is also connected to the work plate 5, wherein the closed casing 6 is arranged in concentric manner with respect to an aperture 500 of the work plate 5. The work plate 5 has handles 510 at its narrow sides. Furthermore, the work plate 5 comprises mounting holes 520, 530 designated to hold the analysis unit 2 rsp. the clamping arm 4 (as shown in FIG. 1).

In FIG. 3, the orifice disk 8 magnified according to FIG. 2 is depicted. The orifices 800 are arranged substantially in circular manner around a central opening 820 of the orifice disk 8. The orifices 800 are of different sizes, in a range between 0.2 mm to 30 mm, preferably in a range of 0.5 mm to 27 mm, arranged in sequence from the smallest orifice 800′ to the biggest orifice 800″. It is also conceivable to arrange the different sizes of the orifices 800 in different manner in the orifice disk 8. The slit 810 is a cleaning slit in order to eliminate dust deposit originating from the tube 7 respectively originating from the casing 6 according to FIG. 1. The slit 810 is arranged in radial manner with respect to the central opening 820 between the smallest and the biggest orifice 800′, 800″. The slit 810 extends from an area of the perimeter of the disk-like orifice disk 8 towards the central opening 820. The orifice disk 8 can be made out of material as metal, ceramics, resin, plastics for example. The material can be coated or uncoated.

In FIG. 4, schematically, an interchangeable test head 3 of an air permeability apparatus 1 is depicted. The opening 300 of the test head 3 with its longitudinal axis LA is running from a top part 320 of the test head 3 to a bottom part 330 of the test head 3 as a central hole. The pressing plate 310 is arranged at the top part 320 of the test head 3. The pressing plate 310 being a ring with a central recess protrudes from the test head 3. Furthermore, the pressing plate 310 is stabilized by resilient elements 340, e.g. as springs, being mounted in the top part 320. The top part 320 is mounted to the clamping arm 4 (not shown in FIG. 4) in up and down movable manner with respect to the bottom part 330. The top part 320 has another handle 350 arranged opposite to a connector, e.g. like two pins 360 of a snap-on mounting designated to be rapidly connected or disconnected against a corresponding receiving part of the clamping arm 4 (see FIG. 1). As explained in FIG. 1, the pressing plate 310 is designated to be clamped against a test specimen (not shown in FIG. 4) rsp. the bottom plate 350 of the bottom part 330. Furthermore, a connecting part 360 of bottom part 330 of the test head 3 is designated to be received by the tube 7 in order to provide an airtight connection, is depicted in FIG. 4. The connecting part 360 is located underneath the work table 5 respectively underneath the pressing plate 310. Both parts 320, 330 of test head 3 are interchangeable, thus different types of test heads each having a different diameter of its circular opening can be selected. The diameter of the different test heads 3 are in a range from 1 cm² to 120 cm², preferably in a range of 5 cm² to 100 cm². The test specimen can be arranged between the pressing plate 310 of the top part 320 and the bottom plate 350 of the bottom part 330 when the test head 3 is not pressed against the work plate 5. By pressing the top part 320 of the test head 3 towards the work plate 5 as depicted in FIG. 1, the vacuum pump 9 is automatically activated.

In FIG. 5a, schematically, an example of the vertically arranged orifice disk 8 is depicted. It is conceivable to mount the orifice disk according to FIG. 5a in the air permeability apparatus 1. An angle β1 of 90° is formed between the orifice disk 8 and the opening 300 of the test head 3. The orifice disk 8 is arranged vertically with respect to the longitudinal axis of the longitudinal opening 300 of the test head 3. It is also conceivable to arrange the orifice disk 8 inclined with respect to the longitudinal axis (see also FIG. 5b) of the longitudinal opening 300 of the test head 3. The ending 700 of the tube 7 covers entirely one of the openings 800 of the orifice disk 8. The air flow trough the tube 7 within the area A within the tube 7 is depicted by an arrow P. Another area B, on the opposite side of the area A resp. of the orifice 800, leads to the other carrier 17 and via a further tube 18 to the vacuum pump 9 as described in FIG. 2.

In FIG. 5b, schematically, the inclined arranged orifice disk 8 is depicted. It is conceivable to arrange the inclined orifice disk 8 in an air permeability apparatus as depicted in FIG. 1. An angle β2, for example of at least 10°, is formed between the orifice disk 8 and the opening 300 of the test head 3. The orifice disk 8 is arranged in said angle with respect to the longitudinal axis of the longitudinal opening 300 of the test head 3. It is also conceivable to arrange the orifice disk 8 vertically with respect to the longitudinal axis (see also FIG. 5a) of the longitudinal opening 300 of the test head 3. The ending 700 of the tube 7 covers entirely one of the openings 800 of the orifice disk 8. The air flow trough the tube 8 within the area A of the tube 8 is depicted by an arrow P. Another area B on the opposite side of the orifice 800 the orifice disk 8 leads to the other carrier 17 and via a further tube 18 to the vacuum pump 9 as described in FIG. 2. It is also conceivable that the angle 32 is for example in a range between 10° to 90°, in particular between 20° to 80°, for example between 40° to 70°. It is also conceivable that the orifice disk 8 is arranged at 90° with respect to the axis x as described in FIG. 5a.

In FIG. 6a, schematically, the clamping arm 2 is pressed down effecting clamping of the test specimen 22 between the top part 320 and the bottom plate 350 of the bottom part 330 of the test head 3. Thus, a first opening 300′ of the top part 320 of the test head 3 is aligned to the second opening 300″ of the bottom part 330 of the test head 3. The first opening 300′ and the second opening 300″ form together the opening 300 of the test head 3. The pressing plate 310 of the top part 320 is stabilized with the aid of stabilizing elements 340, like e.g. springs. The bottom part 5 is mounted in removable manner into the work table 5. Furthermore, the mounting structure 20 of the clamping arm 4 is depicted.

In FIG. 6b, schematically, the clamping arm 4 is positioned in upward direction, i.e. the pressing plate 310 of the top part 320 of the test head 3 is not pressed down anymore against the bottom plate 350 of the bottom part 330 of the test head 3. This position allows changing of both parts of the test head 3, i.e. changing of the top part 320 and changing of the bottom part 330. In this position, the test specimen (not shown in FIG. 6b) can be brought into the designated measuring position.

In FIG. 7a, schematically, another orifice disk 8′ is depicted. The difference to the orifice disk 8 depicted in FIG. 3 is that the other orifice disk 8′ has no slit. The orifices disk 8′ comprises orifices 800. It is conceivable that the orifices can be of different sizes or even some of them can be of the same size. The other orifice disk 8′ can be used for an air permeability apparatus 1 according to FIG. 1. The first ending 710 of the tube 7 resp. its contact area 740 are depicted in dashed lines. Furthermore, a connection element 710 leading to the second carrier 17 resp. to the further tube 18 and to the vacuum pump 9 as described in FIG. 2 is depicted. The features depicted in dashed lines serve to illustrate the pressure air flow through a orifice 800 when the air permeability apparatus 1 is activated. It is conceivable to arrange the orifice disk 8 of FIG. 7a vertically or inclined.

In FIG. 7b, schematically, a further orifice disk 8 is depicted corresponding to the orifice disk depicted in FIG. 3 having orifices 800 and the slit 7. In addition to FIG. 3, the first ending 710 of the tube 7 resp. its contact area 740 are depicted in dashed lines. Furthermore, the connection 170 leading to the second carrier 17 resp.

to the further tube 18 and to the vacuum pump 9 are depicted (see also FIG. 2). It is conceivable to arrange the orifice disk 8 of FIG. 7a vertically or inclined.

In FIG. 7c, schematically, another orifice disk 8′ is depicted corresponding to the orifice disk 8′ depicted in FIG. 7a. The difference to FIG. 7a is that the air jet nozzle 19 is aimed towards the other orifice disk 8′. The other orifice disk 8′ of FIG. 7c can be used for an air permeability apparatus 1 according to FIG. 1. The first ending 710 of the tube 7 resp. its contact area 740 are depicted in dashed lines. Furthermore, the connection 170 leading to the second carrier 17 resp. to the further tube 18 and to the vacuum pump 9 depicted (see also FIG. 2). It is conceivable to arrange the orifice disk 8 of FIG. 7a vertically or inclined.

In FIG. 7d, schematically, another orifice disk 8 according to FIG. 7b is depicted. The difference to FIG. 7b is that the example of FIG. 7d comprises the air jet nozzle 19. The other orifice disk 8 of FIG. 7d can be used for an air permeability apparatus 1 according to FIG. 1. The first ending 710 of the tube 7 resp. its contact area 740 are depicted in dashed lines. Furthermore, the connection 170 is depicted leading to the second carrier 17 resp. to the further tube 18 and to the vacuum pump 9 as described in FIG. 2.

1. An air permeability apparatus (1) comprising a test head (3) with an opening (300), a vacuum pump (9), a clamping arm (4) and an orifice disk (8; 8′) being arranged between a tube (7) and the vacuum pump (9), wherein the orifice disk (8; 8′) has a plurality of orifices (800; 800′; 800″) and is arranged rotatably around its central axis (CA), characterized in that the orifice disk is arranged vertically or inclined with respect to the opening of the test head (3).

2. An air permeability apparatus (1) according to claim 1, characterized in that the orifice disk (8; 8′) is arranged inclined in an angle between 10° to 90°, in particular between 20° to 80°, in particular 40° to 70° , or at 90°.

3. An air permeability apparatus (1) according to claim 1, characterized in that the orifice disk (8; 8′) comprises at least one slit (810) being arranged in radial manner between two orifices (800′, 800″) with respect to the orifice disk (8).

4. An air permeability apparatus (1) according to claim 3, characterized in that the slit (810) extends from an area of the perimeter of the orifice disk (8; 8′) towards a central opening (820) of the orifice disk (8; 8′) and the length of the slit (810) overlaps a contact area (740) between an ending (700) of a tube (7) and a surface of the orifice disk (8; 8′) when the slit (810) is in a cleaning position.

5. An air permeability apparatus (1) according to claim 1, characterized in that an air jet nozzle (19) is aimed towards the orifice disk (8; 8′).

6. An air permeability apparatus (1) according to claim 1, characterized in that the orifices (800) are arranged in radial manner with respect to the central opening (820).

7. An air permeability apparatus (1) according to claim 1, characterized in that the orifices (800; 800′; 800″) have a diameter in a range between 0.2 mm to 30 mm.

8. An air permeability apparatus (1) according to claim 1, characterized in that the orifice disk (8; 8′) is made out of a material as metal, ceramics, resin, plastics, wherein the material is coated or uncoated.

9. An air permeability apparatus (1) according to claim 1, characterized in that the clamping arm (4) comprises a mounting structure (20), wherein a back part of the mounting structure (20) is formed wider than the opening (300) of the test head (3), preferably the mounting structure (20) is bifurcated-like, wherein the mounting structure (20) is pivotable attached to a socket (21).

10. An air permeability apparatus (1) according to claim 1, characterized in that the test head (3) comprises a rapid connection (360), preferably a snap-on mounting, for connecting or disconnecting the test head (3) to the clamping arm (4).

11. An air permeability apparatus (1) according to claim 1, characterized in that the test head (3) comprises a top part (320) and a bottom part (330), which are connectable to each other by pressing the clamping arm (4) downwards.

12. An air permeability apparatus (1) according to claim 1, characterized in that the clamping arm (4) comprises an analysis unit (2), preferably being designated to save and store series of data by using integrated software.

13. An air permeability apparatus (1) according to claim 1, characterized in that another vacuum pump (10) is connected to a closed casing (6), wherein the closed casing (6) is provided in an area of the opening (300) of the test head (3).

14. Method for measuring air permeability with an air permeability apparatus (1) comprising a test head (3) with an opening (300), a vacuum pump (9), a clamping arm (4) and an orifice disk (8; 8′) being arranged between the test head (3) and the vacuum pump (9), wherein the orifice disk (8; 8′) has a plurality of orifices (800; 800′; 800″) and is arranged rotatably around its central axis (CA) and wherein the orifice disk (8; 8′) is arranged vertically or inclined with respect to the opening (300) and, wherein the orifice disk (8; 8′) is arranged vertically spaced from the longitudinal axis of the opening (300) of the test head (3), comprising the steps of:
before establishing a predetermined test pressure, a first cleaning step is performed in blowing air through the orifices (800; 800′; 800″) of the orifice disk (8; 8′);
performing a second cleaning step in aspirating dust deposit of a tube (7) via a slit (810) of the orifice disk (8) by activating the vacuum pump (9).
